(19) United States
(12) Patent Application Publication
(10) Pub. No.: US 2003/0157943 A1
(43) Pub. Date: Aug. 21, 2003

(54) Method and apparatus for auxiliary pilot signal for mobile phone location

(76) Inventor: John Sabat JR., Merrimack, NH (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/352,373

(22) Filed: Jan. 27, 2003

Related U.S. Application Data
(60) Provisional application No. 60/352,617, filed on Jan. 29, 2002.

(51) Int. Cl. H04Q 7/20

(52) U.S. Cl. 455/456; 455/7

(57) ABSTRACT

At repeaters or at each individual unit of a distributed antenna system, an auxiliary pilot signal is transmitted in addition to a common base station pilot signal to mobile units. The auxiliary pilot signal is unique to each repeater and each individual unit of the distributed antenna system within a local propagation area. A mobile unit measures the auxiliary pilot signals received from the repeater or distributed antenna units in the same manner it measures those of any base station pilot signal. The location of the mobile unit can be determined using well-known triangulation techniques based on the auxiliary pilot signal measurements.

### RELATED APPLICATION

This application claims the benefit of U.S. Provisional Application No. 60/352,617, filed on Jan. 29, 2002. The entire teachings of the above application are incorporated herein by reference.

### BACKGROUND

In wireless communication systems, base stations communicate with mobile phone units using standardized radio frequency protocols. To establish and control communication between the mobile phone unit and the base station, the base station uses a forward link pilot signal, also referred to as a control channel. In a code division multiple access (CDMA) system the pilot signal typically uses a pseudo-noise (PN) offset. In time division multiple access (TDMA) systems, a particular frequency and color code are used to characterize the pilot signal. Color code refers to an identification code that distinguishes one base station from another and is usually embedded with the pilot signal. The pilot signals are specified per base station according to a re-use plan common to the particular wireless protocol.

With increased demands for personal safety and security in today's society, wireless service providers are beginning to deploy mobile phone location capabilities. The ability to pinpoint the location of a mobile phone can be provided using well-known triangulation techniques based on relative timing of signals received from three sources having known locations. Particular techniques developed for the wireless industry include enhanced observed time difference (E-OTD), advanced forward link trilateration (AFLT) and observed time difference of arrival (OTDOA).

One of the techniques for locating mobile units is based upon timing measurement of the base stations forward link pilot signal, used in CDMA and wide-band CDMA systems, or digital control channel (DCCH), used in TDMA/GSM systems. The mobile unit measures the timing of these signals from multiple base station sites to compute multiple time difference of arrival (TDOA) hyperbolas, the intersection of which identifies the mobile unit location.

The pilot/DCCH signals are unique for each sector of each base station that is received by the mobile unit. The uniqueness of these signals (i.e., PN offset for CDMA, frequency and color code for TDMA) allows the mobile unit to separately measure each sector's timing.

### SUMMARY

Repeaters and distributed antenna systems present a unique challenge to location measurement. Such systems replicate the source base station's signal and re-transmit that signal, either from the repeater's secondary location in a repeater-based system, or from multiple locations in the case of a distributed antenna system. Thus, there can be conditions where a mobile unit receives multiple replicas of a single base station sector from multiple radiating source locations. The mobile unit may be able to measure the signal from the dominant source (either the host tower or the repeater) depending upon the mobile unit's relative location and local radio frequency (RF) propagation conditions. However, neither the mobile unit, nor a location server (if used) is able to compute a non-ambiguous solution.

The above and other problems are solved by the present approach which is directed to an auxiliary pilot capability.

At repeaters or at each individual unit of a distributed antenna system, an auxiliary pilot signal is transmitted in addition to the common base station pilot signal to mobile units. The auxiliary pilot signal is unique to each repeater and each individual unit of the distributed antenna system within a local propagation area. Selection and assignment of the unique auxiliary pilot parameters (e.g., PN offset for CDMA, frequency and color code for TDMA/GSM) preferably follows the usual PN offset/frequency re-use plan of the particular wireless network, though other assignment plans can be used.

A method of determining location of a mobile unit in a wireless communication system includes transmitting a common base pilot signal from a base station to plural radio access nodes; transmitting auxiliary pilot signals and the common base pilot signal from the radio access nodes, each auxiliary pilot signal having differing signaling parameters; at a mobile unit, receiving the pilot signals and measuring time of arrival of the received pilot signals to provide time of arrival measurements; and determining a location of the mobile unit from the time of arrival measurements.

In an embodiment, the auxiliary pilot signals are generated at a centralized hub location, added to other data streams that include the common base station pilot signal and transmitted to the repeater or units of a distributed antenna system. In another embodiment, the auxiliary pilot signal is generated locally at the repeater or at each unit of the distributed antenna system.

In operation with the present approach, a mobile unit that has been generally adapted to provide mobile location capabilities can simply measure the unique auxiliary pilot signals received from the repeater or distributed antenna units in the same manner it measures those of any base station pilot signal. Accordingly, each pilot signal measurement is associated with a unique geographical location corresponding to a repeater or distributed antenna unit. From the pilot measurements, multiple TDOA hyperbolas are able to be computed, with the location of the mobile unit determined from the intersection of the TDOA hyperbolas. These measurements can also be combined with those for conventional base stations (i.e., without repeaters or distributed antenna units).

The auxiliary pilot signal is not intended for use in call processing (other than location measurements) or as a destination for call hand-off. Since the common base station pilot signal is still replicated and used for call processing, it needs to be omitted from any mobile unit location computation solutions to eliminate location ambiguities. To simplify implementation of the mobile unit, the usual raw pilot measurements associated with the common base station pilot signals are performed by the mobile unit along with those performed for the auxiliary pilot signals. However, a location server can be programmed to consider only those measurements associated with the auxiliary pilot signals and to ignore the measurements for the common base station pilot signals. In other embodiments, mobile units can be further adapted to either only perform measurements for the auxiliary pilot signals or to ignore the measurements for the common base station pilot signals.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a traditional wireless network approach to mobile phone location.

FIG. 2 illustrates a wireless network configuration for which mobile phone location is not possible due to transmission of common pilot signals from a base station/repeater pair.

FIG. 3 shows a wireless network configuration for which mobile phone location is not possible due to simulcasting of the same pilot signal from distributed antenna nodes.

FIG. 4 illustrates a configuration for a repeater that provides a mobile phone location capability according to the present approach.

FIG. 5 shows a configuration for a distributed antenna system that provides a mobile phone location capability in accordance with the principles of the present approach.

FIG. 6 illustrates a wireless network configured in accordance with the present approach.

FIG. 7 is a block diagram of hub equipment adapted according to the principles of the present approach.

FIG. 8 is a block diagram of radio access node equipment adapted according to the principles of the present approach.

### DETAILED DESCRIPTION

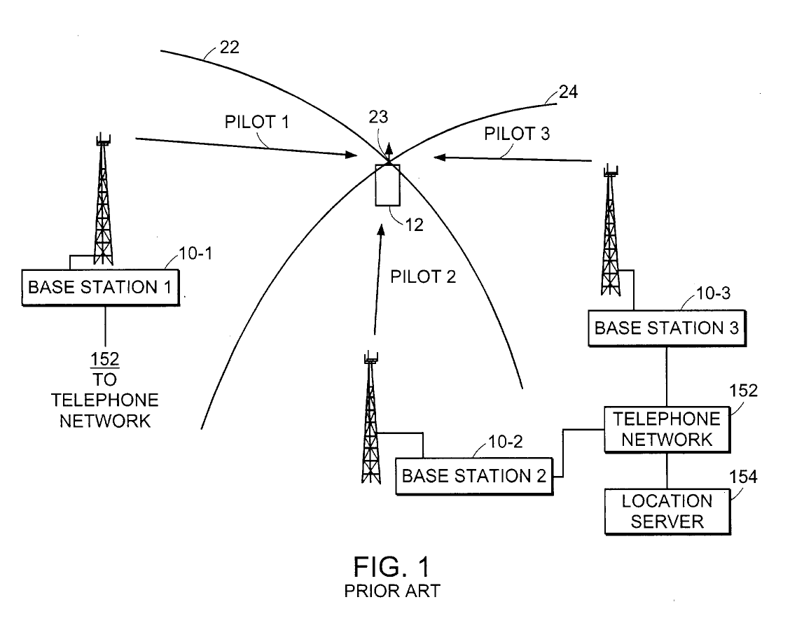

FIG. 1 shows the traditional triangulation approach for determining the location of a mobile unit in a wireless communication system. In operation, a mobile unit 12 receives different pilot signals (pilot 1, pilot 2, pilot 3) from base stations 10-1, 10-2, 10-3, respectively. The mobile unit measures the timing of these signals received from the base stations to compute TDOA hyperbolas 22, 24. Hyperbola 22 is based on measurements of pilot signals 2 and 3. Likewise, hyperbola 24 is based on measurements of pilot signals 1 and 2. The intersection of hyperbolas 22, 24 at point 23 identifies the location of the mobile unit. The location computations can be performed by the mobile unit itself, or the measurements can be relayed over network 152 to location server 154 to perform the computations.

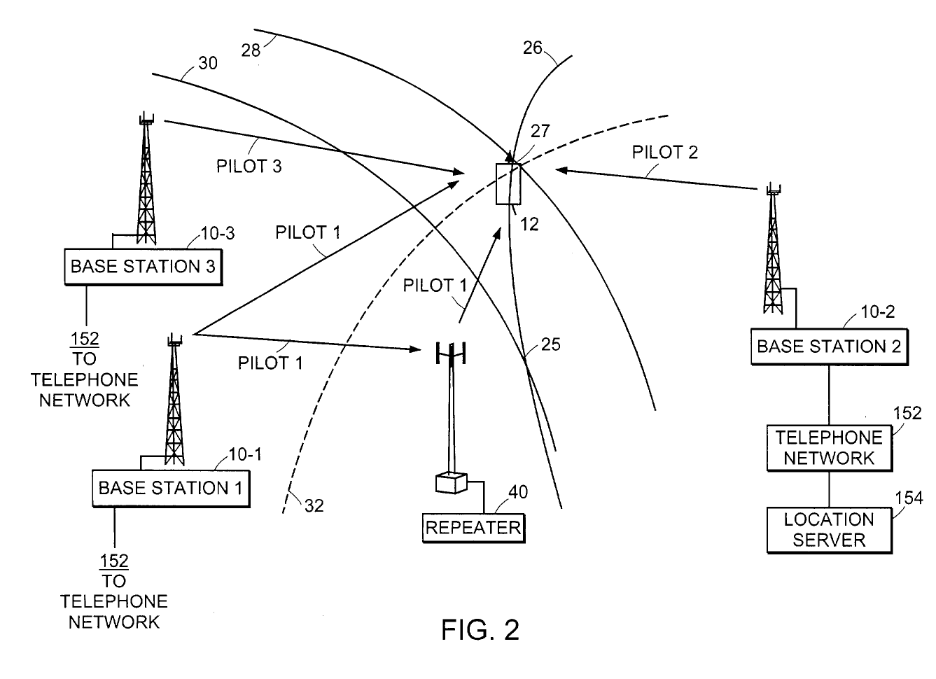

FIG. 2 shows an example of a configuration in which location is not able to be determined because of ambiguity introduced by a tower/repeater pair. In the configuration, mobile unit 12 receives pilot signals from base stations 10-1, 10-2, 10-3. As shown, signals from base station 10-1 are re-transmitted from repeater 40. Thus, the mobile unit also receives a replicated and delayed pilot signal 1 from repeater 40. A TDOA hyperbola 26 can be determined based on measurements of pilot signals 2 and 3. However, measurement of the two versions of pilot signal 1 from base station 10-1 and from repeater 40 yields two possible hyperbolic curves 28, 30. In addition, a meaningful TDOA hyperbola 32 is not possible between base station 10-1 and repeater 40. The result is that there are two ambiguous mobile locations 25, 27 as possible solutions. The ambiguity may be further compounded by the presence of multiple repeaters, distributed antennas, and multiple base station sectors.

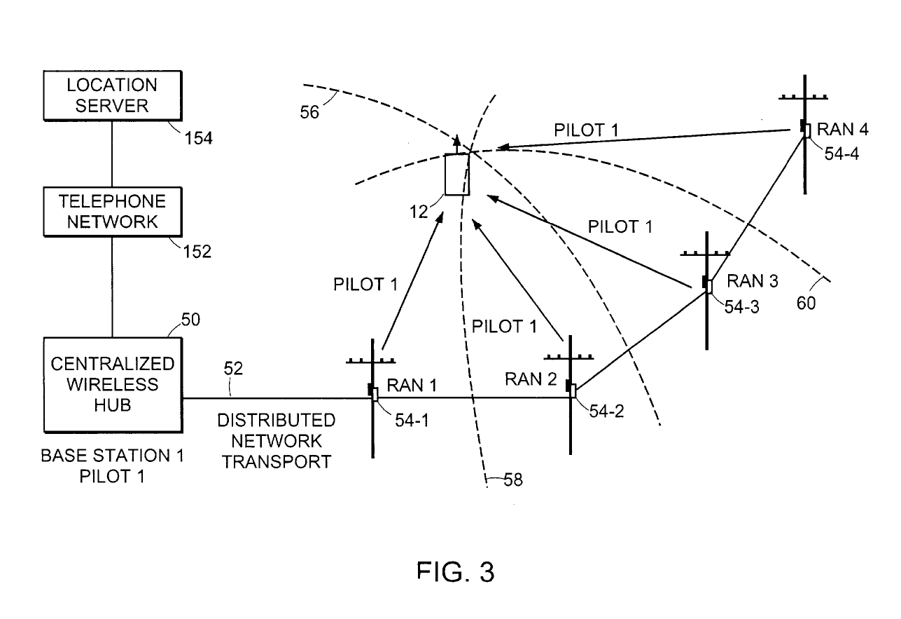

There can also be conditions where a mobile unit only receives multiple replicas of a single base station sector. This readily occurs with a distributed antenna or a base station source hosting multiple repeaters. Under these conditions, no TDOA solution is possible. Under other circumstances, even a timing measurement may not be possible if no one signal source (tower or repeater) is able to dominate the mobile unit's receiver. FIG. 3 illustrates an example distributed antenna system for which TDOA measurement is not possible. In this configuration, base station 50 hosts distributed radio access nodes RAN1, RAN2, RAN3, RAN4 indicated at 54-1, 54-2, 54-3, 54-4, respectively over transport fiber 52. The base station 50 simulcasts the same signals to each radio access node. Since each radio access node transmits replicated pilot signal 1, determination of TDOA hyperbolas 56, 58, 60 is not possible.

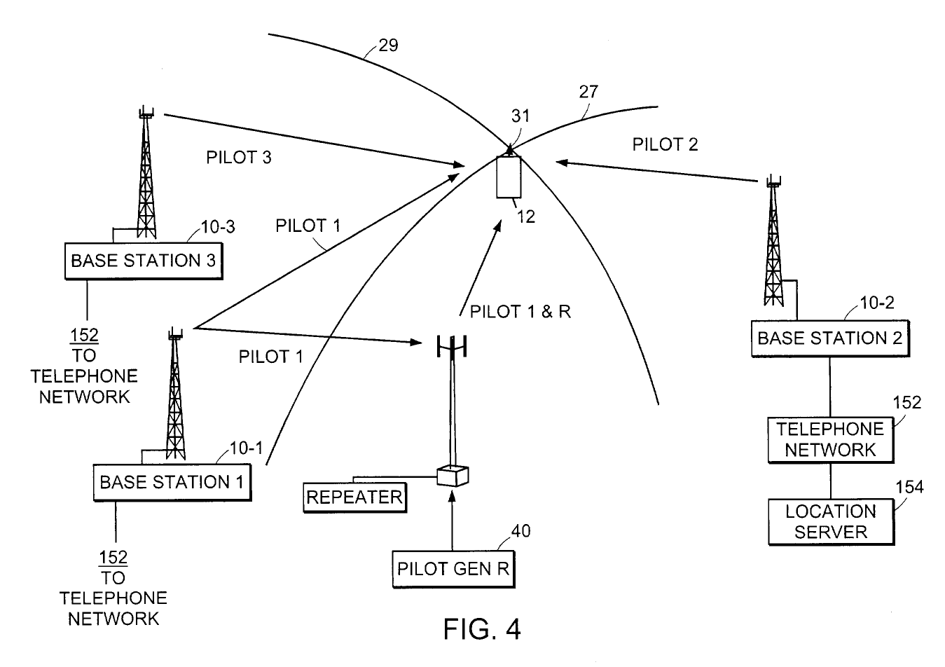

FIG. 4 illustrates a configuration for a repeater that provides a mobile phone location capability according to the present approach. The configuration shows a mobile unit 12 in communication with base stations 10-1, 10-2, 10-3 and a repeater 40 that repeats signals received from base station 10-1. Each base station has its own pilot signal. In this approach, an auxiliary pilot signal R is generated and added to the base station pilot signal 1 at repeater 40. Pilot signal 1 is received at the mobile unit from both base station 1 and the repeater but is not used to provide a solution to the location determination. Rather, the auxiliary pilot signal R is used in conjunction with base station pilot signals 2 and 3 as a basis for TDOA measurements. In particular, TDOA hyperbola 27 can be determined based on measurements of pilot signal 3 and auxiliary pilot signal R. Likewise, TDOA hyperbola 29 can be determined from pilot signal 2 and auxiliary pilot signal R. The intersection of hyperbolas 27, 29 at point 31 identifies the location of the mobile unit. As with the traditional approach (FIG. 1) described above, the location computations can be performed by the mobile unit itself, or the measurements can be relayed over network 152 to location server 154 to perform the computations.

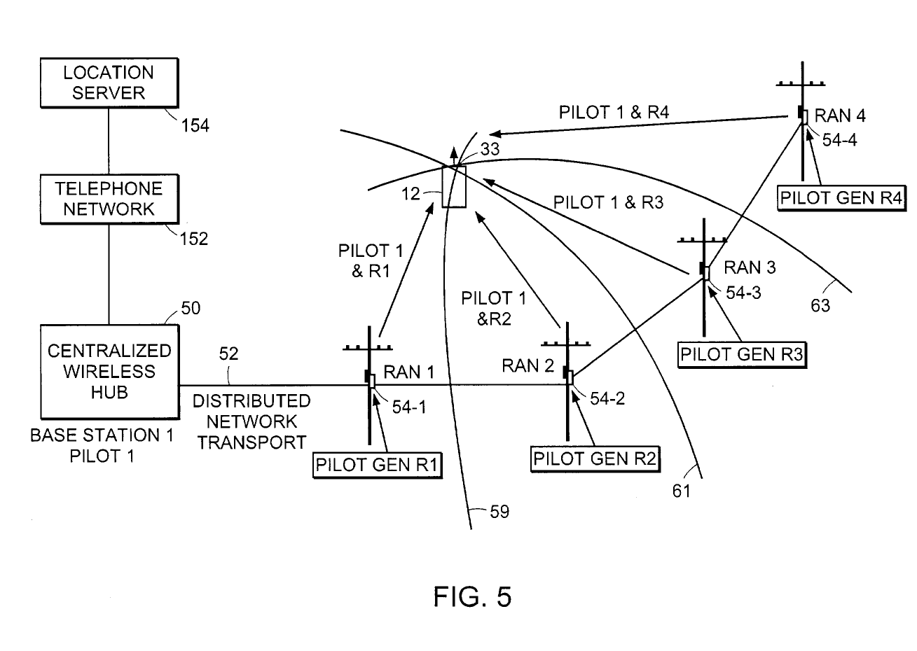

FIG. 5 shows a configuration for a distributed antenna system that provides a mobile phone location capability in accordance with the principles of the present approach. The configuration shows a mobile unit 12 in communication with distributed antenna units or radio access nodes RAN1, RAN2, RAN3, RAN4 indicated at 54-1, 54-2, 54-3, 54-4, respectively. In this approach, unique auxiliary pilot signals R1, R2, R3, R4 are generated and added to the base station pilot signal 1 at each radio access node. The mobile unit uses the auxiliary pilot signals R1, R2, R3, R4 as a basis for TDOA measurements and can ignore the base station pilot signal 1. In particular, TDOA hyperbola 59 can be determined from measurements of auxiliary pilot signals RI and R2. Likewise, TDOA hyperbolas 61 and 63 can be determined based on auxiliary pilot signal pairs R2, R3 and R3, R4, respectively. Note that pilot 1 is not used for determining any TDOA contours. The intersection of hyperbolas 59, 61, 63 at point 33 identifies the location of the mobile unit. The location computations can be performed at the mobile unit or at location server 154.

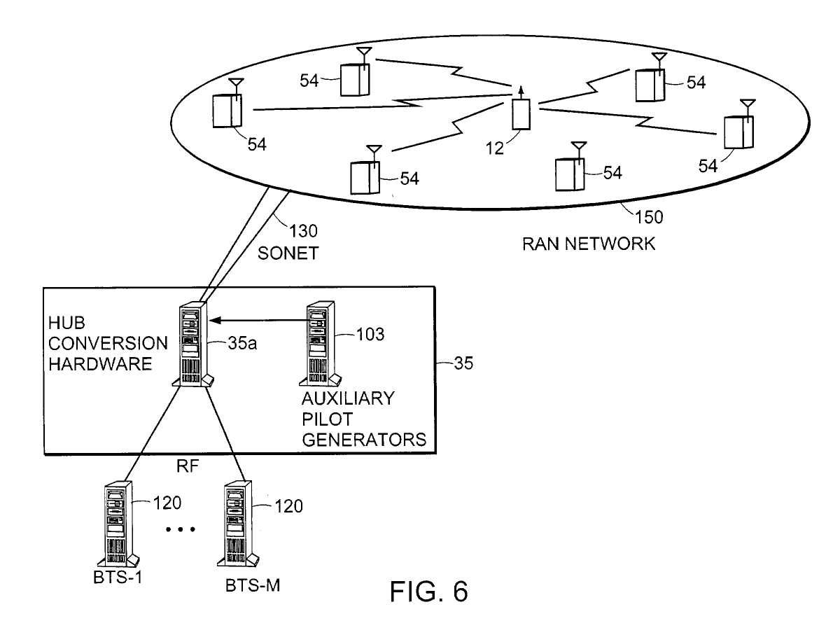

In a particular embodiment, the present approach can be implemented using OpenCell equipment provided by Transcept OpenCell, Inc., of Manchester, N.H., assignee of the present application, and as described in co-pending U.S. patent application Ser. No. 09/818,986, filed on Mar. 27, 2001, entitled “Multi-Protocol Distributed Wireless System Architecture”, which is incorporated herein by reference in its entirety. FIG. 6 illustrates a wireless network configured in accordance with the present approach. The configuration includes base stations BTS-1 to BTS-M 120, the OpenCell hub conversion equipment referenced above and indicated at 35A, SONET distribution 130, and RAN network 150. The hub conversion equipment is adapted to include auxiliary pilot signal generators 103 and is described further herein.

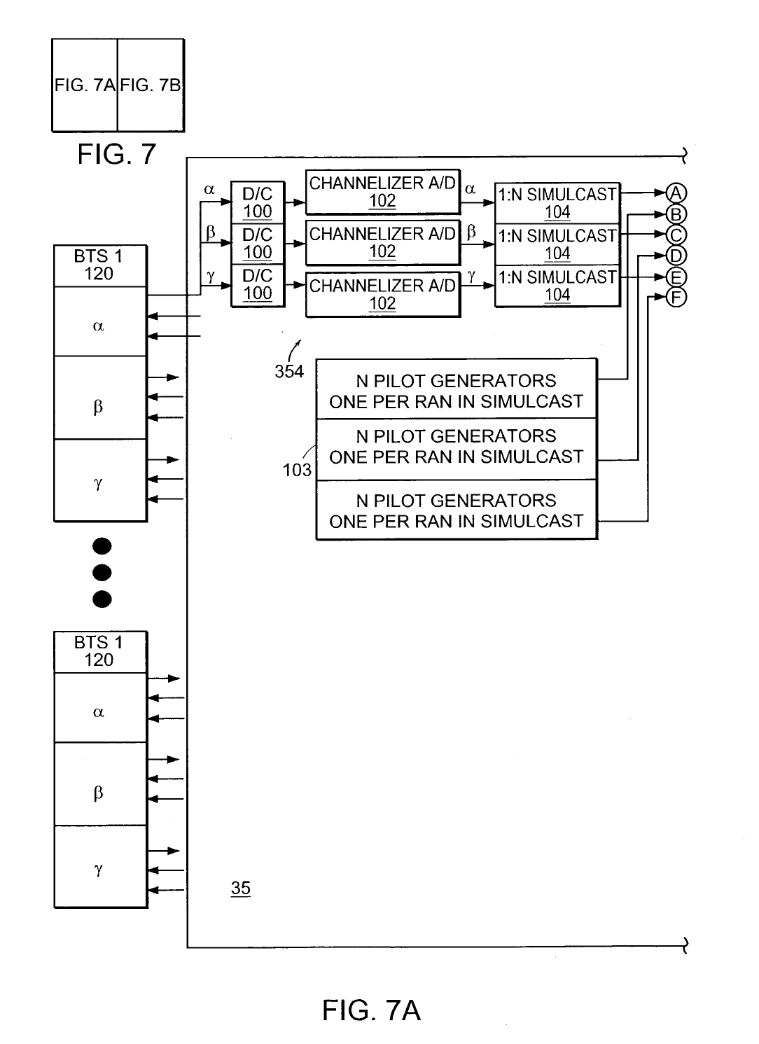

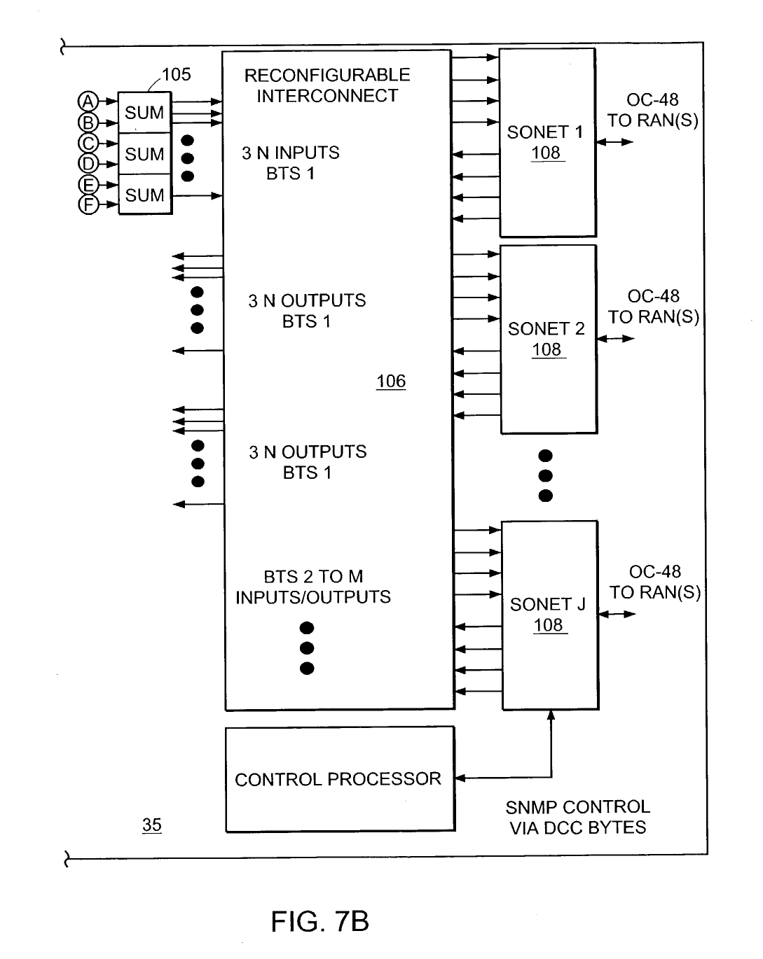

FIG. 7 is a block diagram of the hub equipment of FIG. 6 adapted for the present approach. Such a system includes a base station interface 35 located at a central hub location that converts radio frequency signals associated with multiple base stations 120, of the same or even different wireless service providers, to and from a transport signaling format. A shared transport medium, such as a SONET data network or the like, is then used for transporting the converted signals from the hub location to a number of remote access node locations.

In such a configuration, signal down converter modules 100 convert the radio frequency signals associated with each base station to an Intermediate Frequency (IF) signal. Associated analog to digital (A/D) modules 102 convert the Intermediate Frequency signals to digital signals suitable for handling by a transport formatter 108 that formats the converted digital signals to the proper framing format for the SONET digital transport as described in application Ser. No. 09/818,986.

In the particular adaptation of the hub equipment 35 for the present approach, auxiliary pilot signals, one per RAN, are generated digitally within the centralized hub using auxiliary pilot signal generators 103. At summing nodes 105 the auxiliary pilot signals are digitally added into the data streams which are sent to each RAN from simulcast modules 104 through reconfigurable interconnect 106. Note that in the configuration shown there are three sets of N pilot generators, one per RAN in simulcast, one set per sector. For purposes of clarity, only the forward signal path is shown.

Even though the RANs are simulcast (that is, the same BTS signals simulcast to multiple RANs), the system is organized as multiple point to point digital links from the hub to each RAN. Generating the auxiliary pilot signals within the hub in this embodiment eliminates the hardware impact of generating the pilots within the RAN itself.

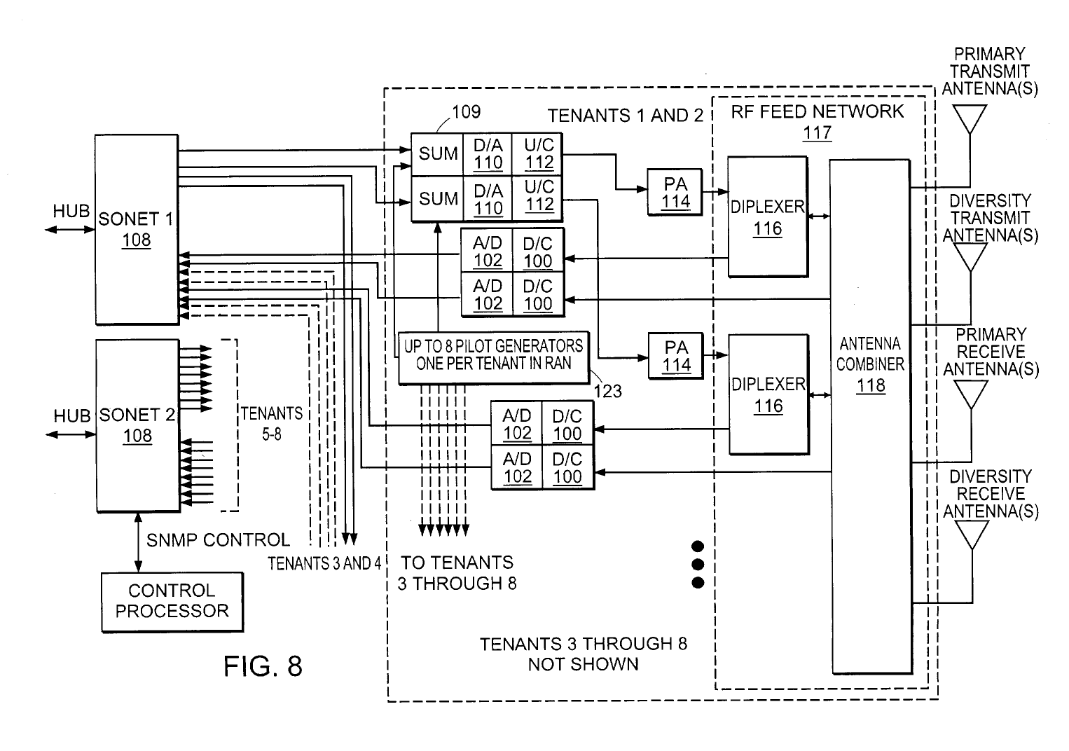

In another embodiment, the auxiliary pilot signals are digitally generated locally at each RAN and added digitally to the digital data streams received at the RAN. FIG. 8 shows a block diagram of radio access node equipment adapted for such an approach. The RANs are each associated with a particular coverage area. The RANs include equipment that converts the radio signals required for a particular service provider to and from the transport signaling format received at SONET modules 108. In particular, auxiliary pilot signals from signal generators 123 are summed with the received digital data streams at summing nodes 109. Associated digital to analog (D/A) modules 110 convert the digital signals to Intermediate Frequency signals suitable for upconversion to RF signals in converters 112. The RF signals are amplified and distributed through RF feed network 117 in the manner described in application Ser. No. 09/818,986. Return signals from the antennas are processed also in the manner described in application Ser. No. 09/818,986. Note that in this particular embodiment which serves up to eight (8) tenants from the RAN, up to eight (8) pilot signal generators 123 are used (one per tenant).

In other embodiments, the auxiliary pilot signal can be generated within each RAN, converted it to IF/RF and summed with the existing IF/RF signals at the RAN.

For CDMA, an alternative mechanism for generating N pilots is the explicit generation of a single reference pilot replicated N times, each with a delay equal to that needed to generate the desired PN offset from the reference pilot.

It is possible for CDMA to measure time delay differences between the base station and its repeater(s) provided relative path delays are greater than chip duration. In actuality, the delayed pilot must have a time offset greater than the longest multipath in the environment to make it distinguishable from multipath. Mobile unit software then can be modified to make this measurement. Note that this approach is coupled to the need for larger search windows for call processing.

It should be understood that any of the approaches for generating the auxiliary pilot signals described herein can also be implemented in repeater based systems.

With any of the approaches described above for generating auxiliary pilot signals, a mobile unit generally adapted for location capabilities (e.g., E-OTD, AFLT, OTDOA) can be used. The present approach can also be combined to augment assisted GPS mobile phone location when the mobile is unable to “see” enough satellites for a GPS-only location solution. Timing measurements in accordance with the present approach can be combined with satellite timing measurements to generate a location solution.

The additional transmit power associated with the addition of an auxiliary pilot signal can be accommodated by performing any of the following: 1) increasing the power amplifier capabilities in the repeaters and distributed antenna units; 2) reducing the power for each traffic channel in order to free up power for the auxiliary pilot signal, thus reducing coverage; 3) reducing the number of simultaneous traffic channels (i.e., capacity). The power levels for the auxiliary pilots can be different from that of the base station pilots to either a) minimize power amplifier burden by using low level settings or b) increase auxiliary pilot overlap by using high level settings.

For coverage and/or capacity reductions, the auxiliary pilot signal can be made active all the time or only activated when a mobile unit needs to be located in the region of the repeater or distributed antenna unit. The latter limits power reduction and signal interference to short term events, which if they occur during non-peak traffic will not affect call capacity on the sector(s) involved. Similarly, for coverage, the sector will not be affected if no mobile units are operating at the limit of the link budget during the mobile location operation.

While this invention has been particularly shown and described with references to preferred embodiments thereof, it will be understood by those skilled in the art that various changes in form and details may be made therein without departing from the scope of the invention encompassed by the appended claims.

What is claimed is:

1. A wireless communication system for determining location of a mobile unit, the system comprising:
plural wireless base stations each transmitting a base pilot signal having signaling parameters that are different for each base station;
a repeater receiving a corresponding base pilot signal from one of the plural base stations and transmitting a repeated base pilot signal and an auxiliary pilot signal having signaling parameters that differ from those of the base pilot signals;
a mobile unit receiving the base pilot signals from the plural base stations and receiving the repeated base pilot signal and the auxiliary pilot signal from the repeater, the mobile unit measuring time of arrival of received pilot signals to provide time of arrival measurements; and
means for determining location of the mobile unit from the time of arrival measurements and from information defining locations of the base stations and the repeater.

2. The system of claim 1 wherein the means for determining location of the mobile unit considers time of arrival measurements corresponding to the non-repeated base pilot signals and the auxiliary pilot signal and ignores the time of arrival measurement corresponding to the repeated base pilot signal.

3. The system of claim 1 wherein the mobile unit is adapted to provide time of arrival measurements only for the non-repeated base pilot signals and the auxiliary pilot signal.

4. The system of claim 1 wherein the mobile unit is adapted to ignore time of arrival measurements for the repeated base pilot signal.

5. The system of claim 1 wherein the means for determining location of the mobile unit is included in the mobile unit.

6. The system of claim 1 wherein the means for determining location of the mobile unit comprises a location server connected to at least one of the plural base stations that receives the time of arrival measurements from the mobile unit.

7. The system of claim 1 wherein the mobile unit is adapted to measure time of arrival based on any of enhanced observed time difference (E-OTD), advanced forward link trilateration (AFLT), and observed time difference of arrival (OTDOA) techniques.

8. The system of claim 1 wherein time of arrival measurements associated with the auxiliary pilot signal are combined with assisted global positioning system measurements.

9. The system of claim 1 further including an auxiliary pilot signal generator for generating the auxiliary pilot signal.

10. The system of claim 1 further including an auxiliary pilot signal generator located with the repeater for generating the auxiliary pilot signal.

11. A wireless communication system for determining location of a mobile unit, the system comprising:
a wireless base station transmitting a base pilot signal;
plural radio access nodes coupled to the base station in a distributed configuration, each of the radio access nodes transmitting a replicated base pilot signal and an auxiliary pilot signal having signaling parameters that are different for each radio access node;
a mobile unit receiving the replicated base pilot signals and the auxiliary pilot signals from the radio access nodes, the mobile unit measuring time of arrival of received pilot signals to provide time of arrival measurements; and
means for determining a location of the mobile unit from the time of arrival measurements and from information defining locations of the radio access nodes.

12. The system of claim 11 wherein the means for determining location of the mobile unit considers time of arrival measurements corresponding to the auxiliary pilot signals and ignores the time of arrival measurements corresponding to the replicated base pilot signals.

13. The system of claim 11 wherein the mobile unit is adapted to provide time of arrival measurements only for the auxiliary pilot signals.

14. The system of claim 11 wherein the mobile unit is adapted to ignore time of arrival measurements for the replicated base pilot signals.

15. The system of claim 11 wherein the means for determining location of the mobile unit is included in the mobile unit.

16. The system of claim 11 wherein the means for determining location of the mobile unit comprises a location server connected to the base station that receives the time of arrival measurements from the mobile unit.

17. The system of claim 11 wherein the mobile unit is adapted to measure time of arrival based on any of enhanced observed time difference (E-OTD), advanced forward link trilateration (AFLT), and observed time difference of arrival (OTDOA) techniques.

18. The system of claim 11 wherein time of arrival measurements of the auxiliary pilot signals are combined with assisted global positioning system measurements.

19. The system of claim 11 further including an auxiliary pilot signal generator that generates the respective auxiliary pilot signals by replicating a reference pilot, each replicated reference pilot having a respective delay to provide a desired PN offset.

20. The system of claim 11 further including at least one auxiliary pilot signal generator for generating the respective auxiliary pilot signals.

21. A wireless communication system for determining location of a mobile unit, the system comprising:
a wireless base station located at a hub location, the base station transmitting radio frequency signals including a base pilot signal;
a base station interface located at the hub, the base station interface converting the radio frequency signals associated with the base station to a transport signaling format;
a shared transport medium transporting the converted radio frequency signals from the hub location to plural remote access node locations;
plural radio access nodes located at the remote access node locations and coupled to receive signals from the shared transport medium, the radio access nodes each associated with a particular portion of a total system coverage area, the radio access nodes each comprising equipment converting from the transport signaling format to radio frequency signals and transmitting the radio frequency signals including the base pilot signal and an auxiliary pilot signal having signaling parameters that are different for each radio access node;
a mobile unit receiving the base pilot signals and the auxiliary pilot signals from the radio access nodes, the mobile unit measuring time of arrival of received pilot signals to provide time of arrival measurements; and
means for determining a location of the mobile unit from the time of arrival measurements and from information defining locations of the radio access nodes.

22. The system of claim 21 wherein the shared transport medium is an optical fiber.

23. The system of claim 21 wherein the shared transport medium uses SONET formatting.

24. The system of claim 21 wherein the means for determining location of the mobile unit considers time of arrival measurements corresponding to the auxiliary pilot signals and ignores the time of arrival measurement corresponding to the base pilot signals.

25. The system of claim 21 wherein the mobile unit is adapted to provide time of arrival measurements only for the auxiliary pilot signals.

26. The system of claim 21 wherein the mobile unit is adapted to ignore time of arrival measurements for the base pilot signals.

27. The system of claim 21 wherein the means for determining location of the mobile unit is included in the mobile unit.

28. The system of claim 21 wherein the means for determining location of the mobile unit comprises a location server connected to the base station that receives the time of arrival measurements from the mobile unit.

29. The system of claim 21 wherein the mobile unit is adapted to measure time of arrival based on any of enhanced observed time difference (E-OTD), advanced forward link trilateration (AFLT), and observed time difference of arrival (OTDOA) techniques.

30. The system of claim 21 wherein time of arrival measurements of the auxiliary pilot signals are combined with assisted global positioning system measurements.

31. The system of claim 21 further including an auxiliary pilot signal generator located at each remote access node location for generating the respective auxiliary pilot signals.

32. The system of claim 21 further including at least one auxiliary pilot signal generator located at the hub location for generating the respective auxiliary pilot signals.

33. A method of determining location of a mobile unit in a wireless communication system, the method comprising:
transmitting radio frequency signals including a base pilot signal from a wireless base station located at a hub location;
converting the radio frequency signals associated with the base station to a transport signaling format;
transporting the converted radio frequency signals from the hub location to plural remote access node locations over a shared transport medium;
receiving signals from the shared transport medium at plural radio access nodes located at the remote access node locations, the radio access nodes each associated with a particular portion of a total system coverage area;
at each radio access node, converting from the transport signaling format to radio frequency signals and transmitting the radio frequency signals including the base pilot signal and an auxiliary pilot signal having signaling parameters that are different for each radio access node;
at a mobile unit, receiving the base pilot signals and the auxiliary pilot signals, and measuring time of arrival of received pilot signals to provide time of arrival measurements; and
determining a location of the mobile unit from the time of arrival measurements and from information defining locations of the radio access nodes.

34. The method of claim 33 wherein determining location of the mobile unit includes considering time of arrival measurements corresponding to the auxiliary pilot signals and ignoring the time of arrival measurement corresponding to the base pilot signals.

35. The method of claim 33 wherein measuring time of arrival includes measuring time of arrival only for the auxiliary pilot signals.

36. The method of claim 33 wherein measuring time of arrival includes ignoring time of arrival measurements for the base pilot signals.

37. The method of claim 33 wherein measuring time of arrival is based on any of enhanced observed time difference (E-OTD), advanced forward link trilateration (AFLT), and observed time difference of arrival (OTDOA) techniques.

38. The method of claim 33 further including generating the respective auxiliary pilot signals at each remote access node location or at the hub location.

39. The method of claim 33 further including generating the respective auxiliary pilot signals by replicating a reference pilot, each replicated reference pilot having a respective delay to provide a desired PN offset.

40. The method of claim 33 further including generating a particular auxiliary pilot signal only when the mobile unit needs to be located in the portion of the coverage area corresponding to the radio access node.

41. The method of claim 33 further including generating the auxiliary pilot signals to have increased power levels with respect to base pilot power levels to thereby increase auxiliary pilot coverage overlap.

42. The method of claim 33 further including generating the auxiliary pilot signals to have decreased power levels with respect to base pilot power levels to thereby reduce power amplifier requirements and signal interference.

43. A method of determining location of a mobile unit in a wireless communication system, the method comprising:
transmitting pilot signals from plural wireless nodes, the pilot signals each having differing signaling parameters and including at least one base pilot signal and at least one auxiliary pilot signal, transmitting further including transmitting one of the at least one base pilot signals from one of the plural nodes to at least one other of the plural nodes, and for the at least one other node, transmitting one of the at least one auxiliary pilot signals and the corresponding one of the at least one base pilot signals;
at a mobile unit, receiving the pilot signals and measuring time of arrival of the received pilot signals to provide time of arrival measurements; and
determining a location of the mobile unit from the time of arrival measurements.

44. The method of claim 43 wherein the plural wireless nodes comprise plural base stations and a repeater and wherein transmitting one of the at least one base pilot signals from one of the plural nodes to at least one other of the plural nodes comprises transmitting a base pilot signal from one of the plural base stations to the repeater.

45. The method of claim 44 wherein determining location of the mobile unit includes ignoring the time of arrival measurement corresponding to the base pilot signal from the one of the plural base stations and considering time of arrival measurements corresponding to the auxiliary pilot signal from the repeater and the base pilot signals from the other of the plural base stations.

46. The method of claim 43 wherein the plural wireless nodes comprise a base station and plural radio access nodes and wherein transmitting one of the at least one base pilot signals from one of the plural nodes to at least one other of the plural nodes comprises transmitting a base pilot signal from the base station to the plural radio access nodes.

47. The method of claim 46 wherein determining location of the mobile unit includes considering time of arrival measurements corresponding to the auxiliary pilot signals from the plural radio access nodes and ignoring the time of arrival measurements corresponding to the base pilot signals.

48. The method of claim 43 wherein measuring time of arrival is based on any of enhanced observed time difference (E-OTD), advanced forward link trilateration (AFLT), and observed time difference of arrival (OTDOA) techniques.

49. The method of claim 43 wherein determining includes determining location from information defining locations of the nodes.

50. A method of determining location of a mobile unit in a wireless communication system, the method comprising:
transmitting a common base pilot signal from a base station to plural radio access nodes;
transmitting auxiliary pilot signals and the common base pilot signal from the radio access nodes, each auxiliary pilot signal having differing signaling parameters;
at a mobile unit, receiving the pilot signals and measuring time of arrival of the received pilot signals to provide time of arrival measurements; and
determining a location of the mobile unit from the time of arrival measurements.

51. The method of claim 50 wherein determining location of the mobile unit includes considering time of arrival measurements corresponding to the auxiliary pilot signals and ignoring the time of arrival measurement corresponding to the common base pilot signal.

52. The method of claim 50 wherein measuring time of arrival is based on any of enhanced observed time difference (E-OTD), advanced forward link trilateration (AFLT), and observed time difference of arrival (OTDOA) techniques.
